(19) United States
(12) Patent Application Publication
(10) Pub. No.: US 2010/0268743 A1
(43) Pub. Date: Oct. 21, 2010

(54) APPARATUS AND METHODS FOR TREE MANAGEMENT ASSIST CIRCUIT IN A STORAGE SYSTEM

(76) Inventors: Basavaraj G. Hallyal, Fremont, CA (US); Robert L. Sheffield, Longmont, CO (US); Mark Ish, Sandy Springs, GA (US); David H. Solina, Oviedo, FL (US); Stephen B. Johnson, Colorado Springs, CO (US); Gerald E. Smith, Longmont, CO (US)

Correspondence Address: Duft Bornsen & Fishman LLP, 1526 Spruce Street, Suite 302, Boulder County, CO, 80302, US

(21) Appl. No.: 12/760,415

(22) Filed: Apr. 14, 2010

Related U.S. Application Data
(60) Provisional application No. 61/169,399, filed on Apr. 15, 2009.

(51) Int. Cl. G06F 17/30; G06F 3/00

(52) U.S. Cl. 707/797; 710/39; 707/E17.012

(57) ABSTRACT

Apparatus and methods for improved tree data structure management in a storage controller. A tree assist circuit coupled with a tree memory is provided for integration in a storage controller. I/O processors of the storage controller transmit requests to the tree assist circuit to create, modify, and access tree data structures stored in the tree memory. In one exemplary embodiment, the tree assist circuit is adapted to manage AVL trees. The tree data structures may be used by the I/O processors of the storage controller to manage region lock requests, cache-line lookup request, and other storage management functions of the controller. The I/O processors of the controller may comprise suitable programmed general-purpose processors and/or fast-path I/O request processor circuits.

This patent application claims priority to U.S. provisional patent application Ser. No. 61/169,399, filed 15 Apr. 2009, which is hereby incorporated by reference.

### BACKGROUND

1. Field of the Invention

The invention relates generally to storage systems and more specifically relates to a tree management assist circuit to manage tree data structures in a storage system.

2. Related Patents

This patent is related to commonly owned U.S. patent application Ser. No. 09/026,8 entitled APPARATUS AND METHODS FOR REGION LOCKING ASSIST CIRCUIT IN A STORAGE SYSTEM, which is hereby incorporated by reference.

3. Discussion of Related Art

Storage systems or devices typically include a storage controller allowing a host system to couple to the storage system/device. The storage device/system receives I/O requests through the controller from attached host systems. I/O requests received by the storage controller may be encoded, for example, as SCSI (Small Computer Systems Interface) commands. Processing of the I/O requests in the storage controller may involve a number of computations and significant data processing. Much of the computations and data processing may involve manipulation of tree data structures. For example, tree data structures may be used in processing of region locks as described in co-pending patent application Ser. No. 09/026,8, for cache-line lookup processing for data stored in a cache memory of the storage controller, and in other processing within the storage controller.

Processing of tree data structures may entail significant processing by a general-purpose processor of the storage controller. Further, some storage controllers may include customized circuits for faster processing of I/O requests (i.e., a “fast-path” I/O processor to improve performance of common read and write I/O request processing). Tree data structures utilized in processing of I/O requests present further problems for such “fast-path” I/O request processing in that the fast-path processing circuits may rely on the general-purpose processor to provide the required tree data structure processing even for the fast-path I/O request processing circuits. Relying on a tree processing algorithm that runs on a general-purpose processor involves substantial overhead for I/Os that are otherwise processed exclusively in hardware (i.e., in the “fast-path” I/O request processing circuit), thereby compromising the potential performance of the I/O processing subsystem.

Thus, it is an ongoing challenge to provide efficient processing of tree data structures in a storage controller.

### SUMMARY

The present invention solves the above and other problems, thereby advancing the state of the useful arts, by providing circuits and methods for fast processing of tree data structures. In one exemplary embodiment, a tree assist circuit in a storage controller provides tree management functions used by either a general-purpose processor of the storage controller or a “fast-path” I/O processor of the storage controller to process I/O requests received from an attached host system. Through the interface the I/O request processing may insert, delete, or modify nodes in a tree data structure. The tree assist circuits may also provide tree data structure rotation features to permit a tree data structure to be re-balanced as may be desired following insertion or deletion of nodes in a tree data structure. In one exemplary embodiment, the tree data structures may be AVL tree data structures.

In one aspect hereof, apparatus is provided in a storage controller of a storage system for managing tree data structures. The apparatus comprises a memory adapted to store a plurality of tree node data structures. The memory is further adapted to store a plurality of tree information data structures, each tree information data structure is adapted to identify a root tree node data structure. The apparatus further comprises an application interface circuit adapted to couple with an application circuit (e.g., a “fast-path” I/O processor and/or a suitably programmed genera-purpose processor) in the storage system and adapted to receive a request from the application circuit to access an identified tree data structure and adapted to return information to the application circuit based on access to the identified tree data structure. The application interface circuit comprising a tree information configuration register adapted to store a starting address in the memory for the plurality of tree information data structures. The apparatus further comprises a tree management circuit coupled with the application interface circuit and coupled with the memory. The tree management circuit adapted to access an identified tree data structure in the memory in response to a request received from an application circuit through the application interface circuit.

Another aspect hereof provides a storage controller. The storage controller comprises a front-end interface adapted for coupling the storage controller to a host system and a back-end interface adapted to couple the storage controller to a plurality of storage devices. The controller also comprises a general-purpose processor coupled with the back-end interface and coupled with the front-end interface. The general-purpose processor is adapted to receive a host system I/O request through the front-end interface and is adapted to process a received I/O request by accessing storage devices through the back-end interface. The storage controller further comprises an I/O request processor coupled with the back-end interface and coupled with the front-end interface and coupled with the general-purpose processor. The I/O request processor is adapted to receive a host system I/O request through the front-end interface and is adapted to process a received I/O request by accessing storage devices through the back-end interface. The controller further comprises a memory adapted to store a plurality of tree node data structures and further adapted to store a plurality of tree information data structures, each tree information data structure is adapted to identify a root tree node data structure. The controller also comprises a tree assist circuit coupled with the general-purpose processor and coupled with the I/O request processor and coupled with the memory. The tree assist circuit comprises a tree information configuration register adapted to store a starting address in the memory for the plurality of tree information data structures and a tree management circuit coupled with the tree information configuration register and coupled with the memory. The tree management circuit is adapted to access an identified tree data structure in the memory. The tree assist circuit is adapted to receive a request from the general-purpose processor and/or from the I/O request processor to access an identified tree data structure and is adapted to return information to the requesting processor based on access to the identified tree data structure.

Still another aspect hereof provides a method operable in a storage controller, the storage controller comprising an I/O request processor and a tree assist circuit and a memory. The method includes receiving an I/O request from an attached host system and transmitting a tree management request from the I/O request processor to the tree assist circuit. The method also includes receiving in the tree assist circuit a request from the I/O request processor, the request for access to an identified tree data structure stored in the memory. The method then accesses, by operation of the tree assist circuit, the identified tree data structure. The access further comprises one or more of the steps of modifying the identified tree data structure and returning information from the identified tree data structure.

### BRIEF DESCRIPTION OF THE DRAWINGS

FIG. 1 is a block diagram of an exemplary storage controller enhanced with a tree assist circuit in accordance with features and aspects hereof to provide improved management of tree data structures in the processing of I/O requests.

FIG. 2 is a block diagram providing exemplary additional details of the structure of the tree assist circuit of FIG. 1.

FIG. 3 is a diagram of an exemplary AVL tree data structure that may be managed by the tree assist circuit of FIGS. 1 and 2 in accordance with features and aspects hereof.

FIG. 4 is a block diagram providing exemplary additional details of the structure of the tree assist circuit of FIG. 1.

FIG. 5 is a flowchart describing an exemplary method for enhanced processing of tree management request using a tree assist circuit in a storage controller in accordance with features and aspects hereof.

### DETAILED DESCRIPTION OF THE DRAWINGS

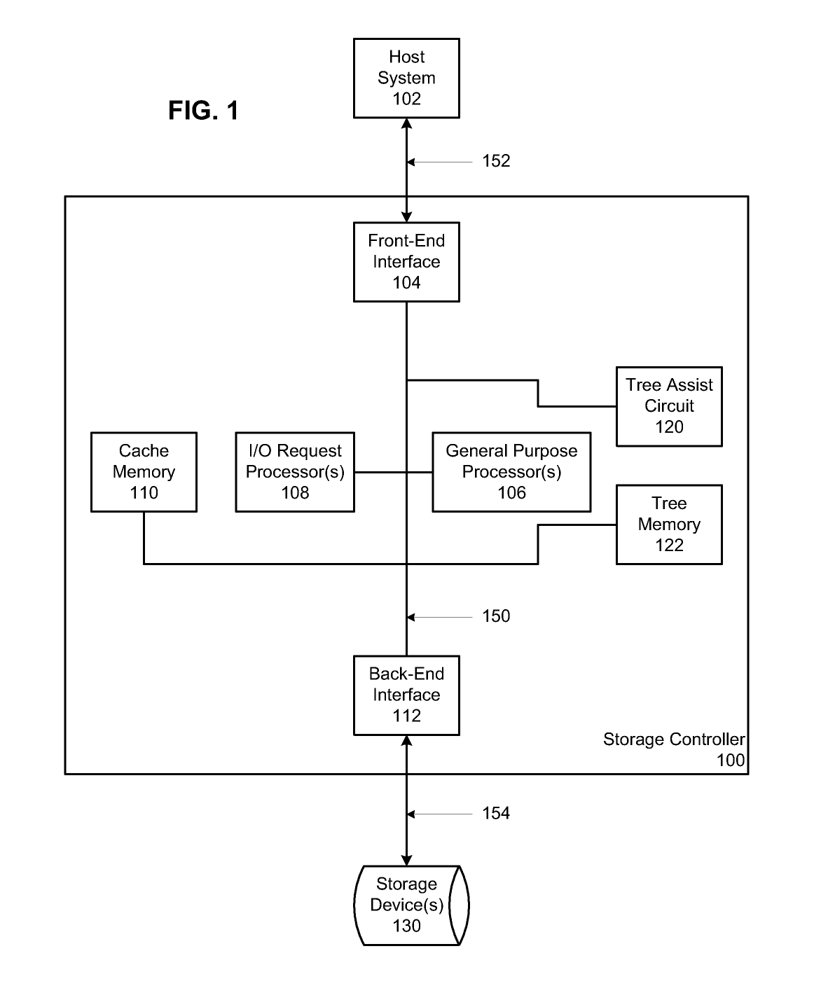

FIG. 1 is a block diagram of a storage controller 100 enhanced in accordance with features and aspects hereof to provide circuits and methods for high speed tree data structure access and management in processing of an I/O request. Storage controller 100 includes general-purpose processor 106 suitably programmed for controlling overall operation of storage controller 100. As depicted in FIG. 1, processor 106 may include any memory suitable for storing data and programmed instructions. In general, general-purpose processor 106 may receive an I/O request from host system 102 through front-end interface 104 via path 152. Front-end interface 104 provides circuitry for coupling storage controller 100 to one or more host systems 102. Front-end interface 104 and communication path 152 coupling the storage controller 100 to host systems 102 may provide any of several well-known communication media and protocols including, for example, PCI, PCI Express, PCI-X, parallel SCSI, Serial Attached SCSI (SAS), Serial Advanced Technology Attachment (SATA), Fibre Channel, Ethernet, etc. In one exemplary embodiment, the front-end interface 104 provides a PCI Express interface over which “SCSI-like” command/response exchanges are conducted. In processing a received I/O request, general-purpose processor 106 communicates with back-end interface 112 to access storage devices 130 via path 154. Back-end interface 112 provides circuitry for coupling storage controller 100 to one or more storage devices 130 via path 154. Back-end interface 112 and communication path 154 may provide any of several well-known communication media and protocols including, for example, parallel SCSI, SAS, SATA, Fibre Channel, etc. General-purpose processor 106 therefore processes a received I/O request to store data on storage devices 130 (e.g., an I/O write request) or to retrieve data from storage devices 130 (e.g., an I/O read request). Storage controller 100 may include cache memory 110 utilized in processing I/O request as well known to those of ordinary skill in the art. Internal bus 150 couples the various elements within storage controller 100 and may comprise any of several well-known bus structures including, for example, PCI, PCI-X, PCI Express, proprietary processor bus structures, etc. In one exemplary embodiment, bus 150 may be a Processor Local Bus (PLB-6) as is commonly used in coupling of Power-PC processor cores. In some embodiments, storage controller 100 may also include an I/O request processor 108 comprising custom circuitry adapted for rapid processing of common I/O request such as read and write request. I/O request processor 108 is sometimes referred to as a “fast-path” request processor in that typical read and write requests from an attached host system 102 may be quickly processed by the dedicated I/O request processor 108 with minimal (or no) processing by general-purpose processor 106.

Storage controller 100 is enhanced in accordance with features and aspects hereof to include tree assist circuit 120 and associated tree memory 122. Tree assist circuit 120 and tree memory 122 may also be coupled to components within storage controller 100 via internal bus 150. Tree assist circuit 120 comprises logic circuits specifically adapted to perform tree data structure management in conjunction with I/O request processing by general-purpose processor 106 and/or I/O request processor 108. As noted above, tree data structures may be useful in processing of I/O request for managing various aspects of the I/O request processing. For example, region locking features or cache-line lookup features may be processed utilizing tree data structures stored in tree memory 122 and managed with the assistance of tree assist circuit 120. In general, general-purpose processor 106 and/or I/O request processor 108 (collectively or individually referred to as I/O processors) interact with tree assist circuit 120 to access and/or modify tree data structures stored in tree memory 122. For example, tree assist circuit 120 may provide an application circuit interface to allow the I/O processors to insert or delete nodes in an identified tree data structure and/or to search an identified tree data structure for particular nodes of interest for the processing of one or more I/O requests. Utilizing the application interface of the tree assist circuit 120, I/O processors may define a new tree for a desired management function in processing of I/O requests directed to one or more volumes stored on storage devices 130. For example, in processing region lock capabilities of storage controller 100, a new tree data structure may be defined for each logical volume defined by the storage system. The tree data structure may then be used to identify regions of the storage volume locked by processing of one or another I/O request. Such a tree data structure may then be used to determine whether a conflict may arise when a new region lock request is received. The nodes of the tree structure may represent granted region locks such that a new region lock request may search the tree to determine whether a new lock request overlaps, and thus, conflicts with, a previously granted region lock request.

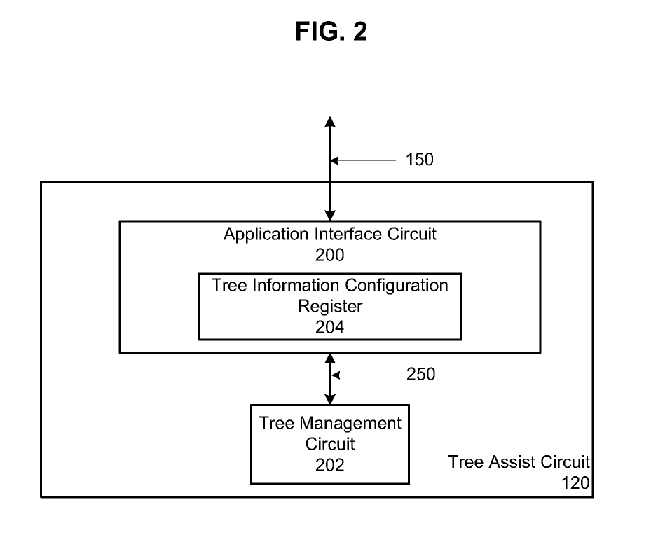

FIG. 2 is a block diagram providing additional exemplary details of tree assist circuit 120 of FIG. 1. In one exemplary embodiment, tree assist circuit 120 includes application interface circuit 204 coupling tree assist circuit 120 with I/O processors of the storage controller via bus 150. Among other components, application interface circuit 200 may include a tree information configuration register 204 adapted for storing a starting address in an associated tree memory (e.g., tree memory 122 of FIG. 1) for a plurality of tree information (TREE_INFO) data structures. In addition, tree assist the circuit 120 may include tree management circuit 202 comprising logic circuits for accessing and/or modifying identified tree data structures. A request to access an identified tree data structure may be received via a bus 150 through the application interface circuit 200 and forwarded via path 250 to tree management circuit 202 for processing. Path 250 may be any desired internal bus structure or may simply represent the integration of application interface circuit 200 with associated logic circuits of tree management circuit 202.

The plurality of TREE_INFO data structures may be stored in contiguous memory starting from the base address stored in the tree information configuration register 204. Those of ordinary skill in the art will readily recognize other information that may be stored in the tree information configuration register. The following table exhibits exemplary fields of an exemplary tree information configuration register 204:

| | Length | |
|---|---|---|
| Field | (bytes) | Description |
| TreeInfoBase | 4 | Base address of an array of TREE_INFO |
| | | data structures |
| UpperAddress | 4 | Specifies the upper 32-bits for all |
| | | addresses of TREE_INFO data structures |
| | | and tree node data structures (only 4 |
| | | bits are significant) |
| Enable | 4 | A non-zero value enables the tree assist |
| | | circuits. A value of zero halts (pauses) |
| | | the tree assist circuits so that appli- |
| | | cation circuits may perform “fix-up” oper- |
| | | ations on the managed data structures. |
| Unused | 4 | For 16-byte alignment |

Each TREE_INFO data structure includes a pointer to a root tree node (TREE_NODE) data structure of the associated tree data structure. Other fields may be present in each TREE_INFO data structure as a matter of design choice. In one exemplary embodiment, the following table exhibits exemplary fields of an exemplary TREE_INFO data structure:

| | Length | |
|---|---|---|
| Field | (bytes) | Description |
| Root | 4 | A pointer to the root TREE_NODE of a |
| | | tree. NULL if the tree has no entries. |
| Compare | ½ | Indication of which key compare method |
| | (bits | to use for this tree |
| | 3:0) | 0: 56-bit key values unsigned compare, |
| | | with result of <, =, or > (e.g., for |
| | | Region Locks) |
| | | 1: 120-bit key values unsigned compare, |
| | | with result of <, =, or > (e.g., for |
| | | RAID cache-line look-up) |
| | | 2-15: Reserved |
| Change | ½ | Application circuits should set to |
| Method | (bits | select action to take by tree assist |
| | 7:4) | circuit when TREE_NODE locations are |
| | | changed by rotations: |
| | | 0x0: CHANGE_NONE - take no action |
| | | 0x1: CHANGE_UPDATE_MAX - update for |
| | | Region Locking applications |
| | | 0x2-0xF: reserved |
| reserved | 1 | Reserved |
| pad | 2 | For 8 -byte alignment |

In an alternate embodiment, the above exemplary data structure may be represented more compactly by encoding the “Compare” and “Change Method” fields (comprising a total of 4 bits) as the low order bits of the otherwise 32-bit address of the root. In other words, a TREE_INFO data structure may be more compactly encoded as a single 32-bit word with the high order 28 bits representing the high order 28 bits of the address of the root of the tree (presuming the root tree node to be aligned at a 32 byte boundary). The low order 4 bits then represent the compare and change fields described above.

Each TREE_NODE of a tree data structure includes a key field used for storing information encoded by the TREE_NODE. The key values are used to order the nodes of the tree such that the tree data structure may be “walked” or “traversed” in order of the key values. In addition, each TREE_NODE data structure may include pointers to a left branch sub-tree of the node and to a right branch sub-tree of the node. Still further, each TREE_NODE data structure may include a pointer to its parent TREE_NODE in the tree data structure. Lastly, where the tree structure is implemented as an AVL tree structure, each TREE_NODE data structure may include a balance field indicating the degree of balance or imbalance of the sub-trees descending from the corresponding TREE_NODE data structure. The balance field value may be used to guide modification operations of the tree assist circuit to minimize the height of a tree data structure as measured from the most distant leaf node to the root node of a tree. The following table describes exemplary fields of a TREE_NODE data structure in one exemplary embodiment hereof:

| Bytes | Field | Description | |
|---|---|---|---|
| 0-3 | Key Low | Low order 32 bits of key value for all usages | Key |
| 4-7 | Key | Next higher-order bits of key value - high | (≦120 |
| | Med/Low | order byte may be used for auxiliary infor- | bits) |
| | | mation if Key ≦ 7 bytes (56 bits) | |
| 8-11 | Key | May be used for auxiliary information if | |
| | Med/High | Key ≦ 8 bytes | |
| 12-14 | Key High | May be used for auxiliary information if | |
| | | Key ≦ 12 bytes | |

| | | |
|---|---|---|
| 15 | Balance | For a given node, the height of its right sub- |
| | | tree minus the height of its left sub-tree |
| | | {<=0: left heavy, =0: balanced, >0: right heavy}. |
| | | A sub-tree with a balance value other than −1, |
| | | 0, or 1 needs to be rebalanced. |
| 16-19 | Parent | Pointer to the Parent TREE_NODE element |
| | pointer | |
| 20-23 | Left | Pointer to TREE_NODE at the top of the left |
| | pointer | sub-tree |
| 24-27 | Right | Pointer to TREE_NODE at the top of the right |
| | pointer | sub-tree |
| 28-31 | Aux | May be used for application circuit specific |
| | | information |

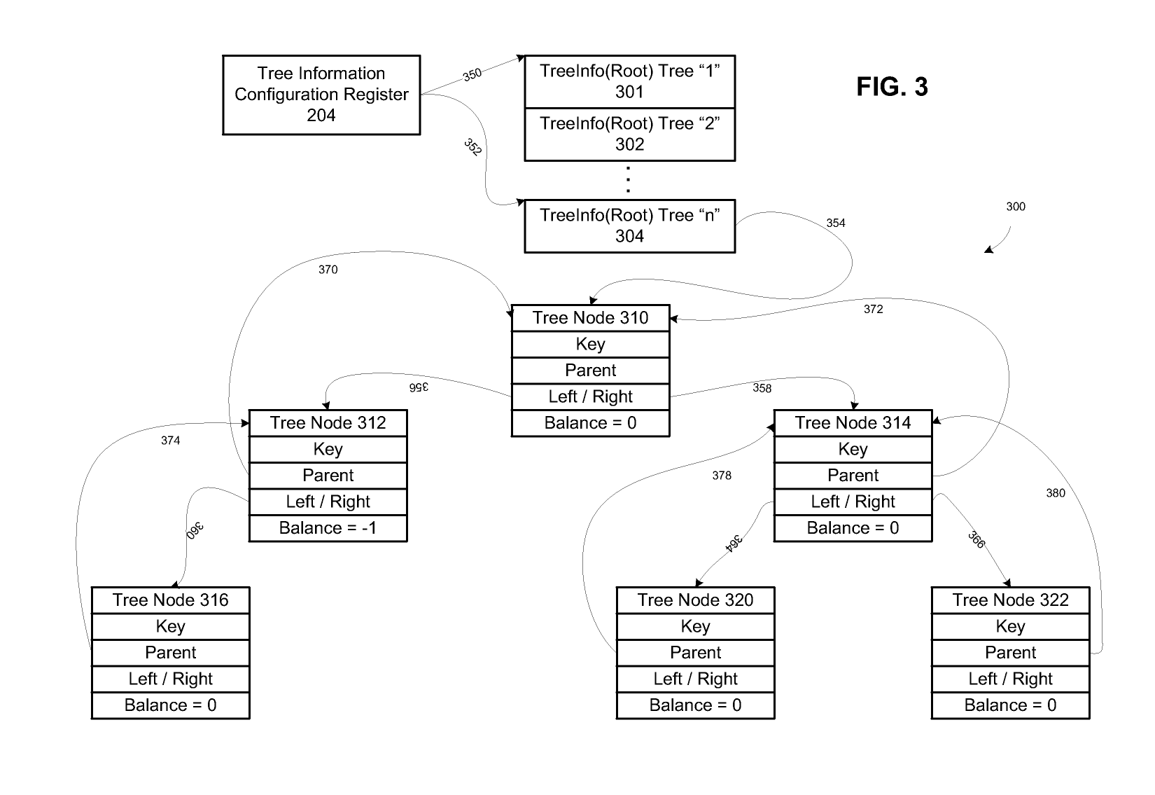

FIG. 3 is a block diagram depicting an exemplary tree data structure 300 linked as an AVL tree data structure in accordance with features and aspects hereof. The tree information configuration register 204 includes a base address pointer 350 indicating the start of a contiguous range of TREE_INFO data structures 301 through 304 (e.g., stored in contiguous locations of the tree memory 122 of FIG. 1 in accordance with an exemplary embodiment). Using the tree information configuration register base address pointer 350 plus an offset to a desired tree, pointer 352 may be determined pointing to the TREE_INFO data structure associated with a desired tree (e.g., tree “n” 304). The offset from the base address pointer 350 may be supplied in a tree management request as a tree index value—an index into the array of contiguous TREE_INFO data structures 301 through 304. The index value may be multiplied by the fixed size of each TREE_INFO data structure to determine the offset and thus the value of the identified tree pointer 352.

The root pointer field 354 of the identified TREE_INFO data structure 304 points to the root TREE_NODE 310 of the identified tree data structure to be accessed by a tree management request. Each of the other TREE_NODEs (312 through 322) are “children” of the root TREE_NODE 310. Based on the exemplary TREE_NODE data structure described above, each TREE_NODE structure 310 through 322 includes a corresponding key field, a parent pointer field, a left and right sub-tree pointer field, and a balance field. As the root node of the identified tree, TREE_NODE 310 includes a left sub-tree pointer 356 pointing to its left child sub-tree starting with TREE_NODE 312 and a right sub-tree pointer 358 pointing to its right child sub-tree starting with TREE_NODE 314. These child TREE_NODEs 312 and 314 each include a parent pointer (370 and 372, respectively) pointing back to their parent TREE_NODE 310. TREE_NODE 312 includes a left sub-tree pointer 360 pointing to TREE_NODE 316. TREE_NODE 312 has no right sub-tree and thus the right sub-tree pointer value would be nil (e.g., zero). Since TREE_NODE 312 has no right sub-tree and the depth of its left sub-tree is only a single node, the balance field value of TREE_NODE 312 is −1. TREE_NODE 316 include a parent pointer 374 pointing back to parent TREE_NODE 312. Still further, TREE_NODE 314 includes a left sub-tree pointer 364 pointing to TREE_NODE 320 and a right sub-tree pointer 366 pointing to TREE_NODE 322. TREE_NODEs 320 and 322 each include a parent pointer, 378 and 380, respectively, pointing back to parent TREE_NODE 314. As leaf nodes in the tree structure, the left and right child pointers of node 316, 320, and 322 are all nil (e.g., zero). TREE_NODEs 310, 314, 316, 320, and 322 all have balance field values of zero indicating equal balance on their respective left and right sub-trees. Since no node of tree 300 has a balance field value other than −1, 0, and 1, tree 300 is deemed balanced and does not require any re-balancing operations. Tree 300 of FIG. 3 is merely intended as one exemplary tree structure to suggest the general structure of an exemplary AVL tree in accordance with features and aspects hereof.

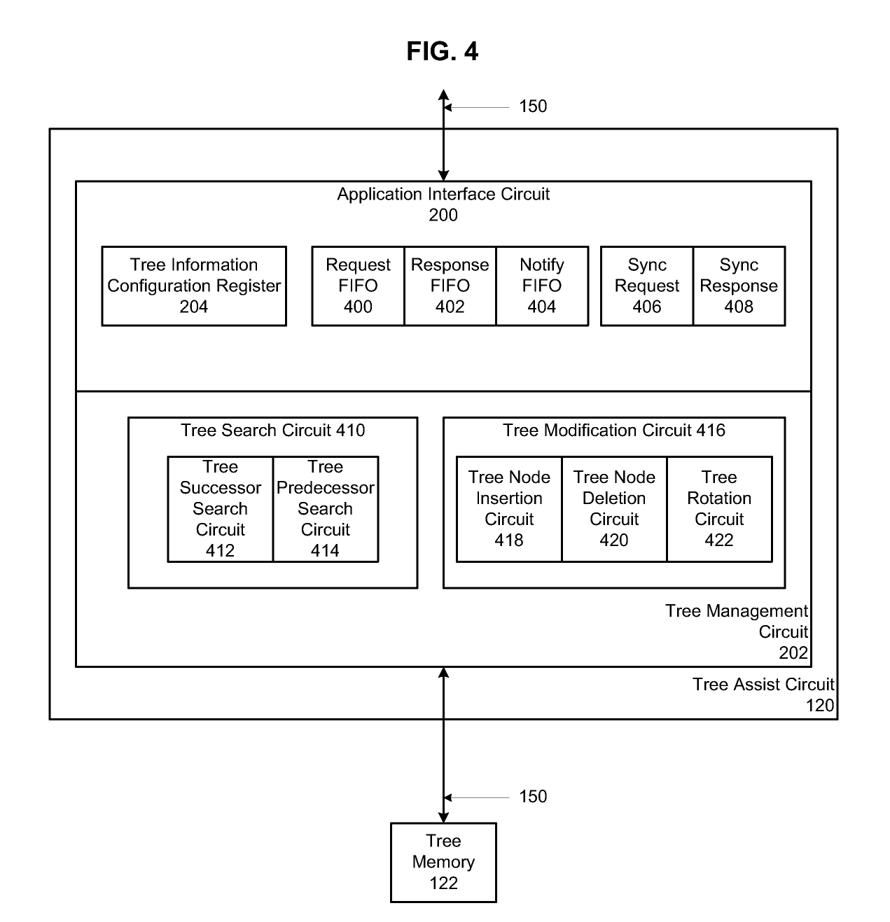

FIG. 4 is a block diagram depicting additional exemplary details of tree assist circuit 120 of FIGS. 1 and 2. As noted above, tree assist circuit 120 may include an application interface circuit 200 that comprises tree information configuration register 204. In addition, application interface circuit 200 may include means for interfacing with application circuits (e.g., I/O processors) to receive and process tree management requests. Request FIFO 400, response FIFO 402, and notify FIFO 404 collectively comprise an asynchronous interface for application circuits to request tree management functions. An application circuit may add a request to request FIFO 400 and continue processing other aspects of a corresponding I/O request. When the tree management request is completed by tree assist circuit 120 an appropriate response is added to response FIFO 402. Further, an entry is added to notify FIFO 404 to permit the requesting application circuit to be notified of the completion of the request. The response FIFO 402 may be used to signal completion of specific requests to a requesting application circuit. The notify FIFO 404 may be used to trigger application circuit processing that must track any changes made to the tree structure, independent of whether those changes result from specific requests or other causes. An example is use by a region lock manager to adjust the value of a Max field associated with any given TREE_NODE that indicates the span of key values for all child tree nodes below the TREE_NODE of interest. A notify FIFO 404 entry may be used to optimize tree search algorithms for trees used in region lock processing.

In addition, sync request 406 and sync response 408 comprise a synchronous interface whereby an application circuit may issue a request in the sync request interface 406 and await a corresponding response in the synchronous response interface 408 before continuing any further processing of an I/O request. A synchronous request and response may be performed when the application circuit cannot proceed further with processing until the tree management request is completed. By contrast, an asynchronous request and response may be appropriate where the application circuit is capable of proceeding with further processing while awaiting the completion of the tree management request. Those of ordinary skill in the art will recognize standard arbitration logic that may be associated with the application interface circuit 200 to help avoid conflicts from simultaneous requests. Such arbitration logic is well known to those of ordinary skill in the art and thus omitted for simplicity and brevity of this discussion. Other features and logic of the tree assist circuit 120 help avoid processing of conflicting or incoherent requests from multiple application circuits.

Tree management circuit 202 may include a tree search circuit 410 and a tree modification circuit 416. Tree search circuit 410 comprises logic circuits for searching an identified tree data structure based on a particular supplied key value. In addition, tree search circuit 410 may include tree successor search logic 412 and tree predecessor search logic 414 for locating a succeeding or preceding TREE_NODE in an identified tree data structure based on a provided key value. Tree modification circuit 416 may include a TREE_NODE insertion circuit 418 adapted to insert a provided new TREE_NODE into an identified tree data structure. Tree modification circuit 416 may include TREE_NODE deletion circuit 420 adapted to delete an identified TREE_NODE from an identified tree data structure. Tree rotation circuit 422 within tree modification circuit 416 provides functionality to rebalance or rotate an identified tree data structure. The rotation or rebalance function of tree rotation circuit 422 may be invoked directly by an application circuit or may be indirectly invoked as an aspect of processing an insertion or deletion of a TREE_NODE by circuit 418 and 420, respectively.

Rotation operations for AVL tree data structures are well known to those of ordinary skill in the art. After the insertion of each node or deletion of a node, the tree should be checked for balance. Once the tree is found to be out-of-balance then re-balance it using the appropriate algorithm. An exemplary algorithm for required rotations to re-balance an AVL tree is as follows:

Step 1: Set up the pointers:
A—points to the node that is out of balance. If more than one node is out of balance then select the one that is furthest from the root. If there is a tie then a previous out-of-balance condition was missed.
B—points to the child of A in the direction of the out-of-balance
C—points to the child of B in the direction of the out-of-balance
F—points to the parent of A. This is the only pointer of these 4 that is allowed to be NULL.
   Step 2: Determine the appropriate algorithm:
The algorithms for the four possible cases are referred to by the letters RR, LL, RL, and LR. The first letter of the algorithm represents the direction from A to B (either “R” Right or “L” Left). The second letter represents the direction from B to C (either “R” Right or “L” Left).
   Step 3: Follow the determined algorithm from those below:

RR:

A.Right = B.Left
B.Left = A
If F = NULL

B is new Root of tree

Else

If F.Right = A

F.Right = B

Else

F.Left = B

End If

End If

LL:

A.Left = B.Right
B.Right = A
If F = NULL

B is new Root of tree

Else

If F.Right = A

F.Right = B

Else

F.Left = B

End If

End If

RL:

B.Left = C.Right
A.Right = C.Left
C.Right = B
C.Left = A
If F = NULL

C is new Root of tree

Else

If F.Right = A

F.Right = C

Else

F.Left = C

End If

tab;End If
LR#:

A.Left = C.Right
B.Right = C.Left
C.Left = B
C.Right = A
If F = NULL

C is new Root of tree

Else

If F.Right = A

F.Right = C

Else

F.Left = C

End If

End If

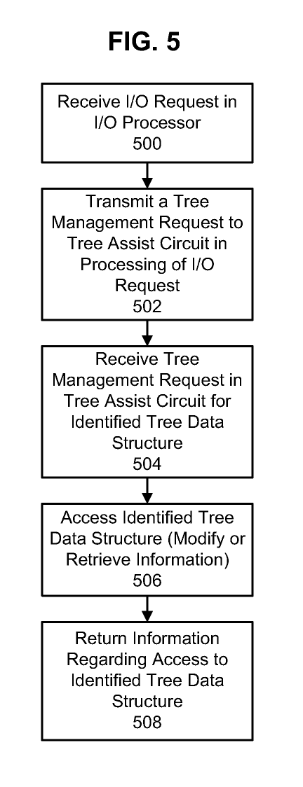

FIG. 5 is a flowchart describing an exemplary method in accordance with features and aspects hereof. The method of FIG. 5 may be performed in a storage controller such as controller 100 of FIG. 1 enhanced with a tree assist circuit such as circuit 120 of FIGS. 1, 2, and 4. Step 500 receives an I/O request from an attached host system. In response to receipt of the I/O request, the I/O processor of the storage controller may need to perform tree management functions. Step 502 then transmits a tree management request from the I/O processor of the controller to the tree assist circuit of the controller. The tree management request is received in the tree assist circuit at step 504 and step 506 performs the requested access to the identified tree data structure. The requested access may modify the tree data structure (e.g., by inserting or deleting nodes) and/or may simply request information be returned from the tree data structure (e.g., locate a particular key value in a node, locate a node having the nearest key value to a desired key value, locate a successor or predecessor node to a node having a desired key value, etc.). Step 508 then returns information regarding the requested access to the I/O processor of the storage controller to permit continued processing of the received I/O request.

Exemplary functions provided by tree assist circuit 120 are discussed in the table below. The table indicates a particular type of request or function to be performed as may be entered in the async request FIFO 400 or the sync request interface 406 and corresponding response information that may be entered in the async response FIFO 402 or the sync response interface 408. A description of the processing performed for each tree management operation is also provided in the table below.

| Request Name and Exemplary | | | |
|---|---|---|---|
| Encoded Command ID | Parameters | Response | Description |
| TreeSearch | Tree Index, | Status = FOUND | Search the AVL tree |
| (0x01) | Key | or MISSING | starting at the root of the |
| | | Post response FIFO | tree identified by Tree |
| | | entry. | Index for the entry with the |
| | | | specified Key and return a |
| | | | pointer to a TREE_NODE |
| | | | with a matching key, or |
| | | | MISSING if not found. |
| TreeSearchNearest | Tree Index, | Status = FOUND | Search the AVL tree |
| (a.k.a., TreeFind) | Key | or EMPTY | starting at the root of the |
| (0x02) | | Post response FIFO | tree identified by Tree |
| | | entry. | Index for the entry with the |
| | | | specified Key and return a |
| | | | pointer to the node with a |
| | | | key value closest to, but not |
| | | | less than, the key supplied, |
| | | | or EMPTY if the root is |
| | | | NULL. |
| TreeSuccessor | Tree Index, | Status = FOUND | Find, starting at the root |
| (0x03) | Node | or MISSING | node of the tree identified |
| | Pointer | Post response FIFO | by Tree Index, the node |
| | | entry. | with the lowest key value |
| | | | that is greater than the key |
| | | | value of the node specified |
| | | | by Node Pointer by |
| | | | traversing the left links to |
| | | | the first NULL link, starting |
| | | | with the right child of the |
| | | | specified node. This is used |
| | | | to facilitate identification of |
| | | | rotation nodes for |
| | | | rebalancing the tree. |
| TreePredecessor | Tree Index, | Status = FOUND | Find, starting at the root |
| (0x04) | Node | or MISSING | node of the tree identified |
| | Pointer | Post response FIFO | by Tree Index, the node |
| | | entry. | with the highest key value |
| | | | that is less than the key |
| | | | value of the node specified |
| | | | by Node Pointer by |
| | | | traversing the right links to |
| | | | the first NULL link, starting |
| | | | with the left child of the |
| | | | specified node. |
| TreeInsert Silent | Tree Index, | Update request | Find, starting at the root |
| (0x05) | Node | status. | node of the tree identified |
| | Pointer | Status = | by Tree Index, the branch to |
| | | INSERT DONE, | insert the new node |
| | | TreeIndex, context | identified by Node Pointer. |
| | | No FIFO response | Navigate left and right to |
| | | generated. | find a leaf node such that |
| TreeInsert | Tree Index, | Update request | the key value of the new |
| Verbose | Node | status. | node is between the key |
| (0x15) | Pointer | Status = | values of the leaf node and |
| | | INSERT DONE, | its parent (smaller keys go |
| | | TreeIndex, context | left, higher keys go right). |
| | | Post response FIFO | The leaf becomes the |
| | | entry. | inserted node's parent. |
| | | | Rebalance the tree towards |
| | | | the root. |
| TreeDelete Silent | Tree Index, | Update request | Delete the node specified |
| (0x06) | Node | status. | by Node Pointer from the |
| | Pointer | Status = | tree identified by Tree |
| | | DELETE DONE, | Index; swapping the |
| | | TreeIndex, context | “successor” branch into the |
| | | No FIFO response | deleted node's slot in case |
| | | generated. | the deleted node had two |
| TreeDelete | Tree Index, | Update request | children; and then rebalance |
| Verbose | Node | status. | the tree upwards. |
| (0x16) | Pointer | Status = | |
| | | DELETE DONE, | |
| | | TreeIndex, context | |
| | | Post response FIFO | |
| | | entry. | |

As noted, the requests and replies to tree management requests may be entered in corresponding FIFOs. In one exemplary embodiment, the request and response FIFO entries are pointers to corresponding request and response descriptors. In other embodiments, as a matter of design choice, the entries in the FIFOs are the actual request and response descriptors. An exemplary request/response descriptor is shown in the table below:

| | Byte/Bit | | | | | |
|---|---|---|---|---|---|---|
| | 3 | 2 | | 1 | 0 | |
| D-Word | 31 30 29 28 27 26 25 24 | 23 | 22 21 20 19 18 17 16 | 15 14 13 12 11 10 9 8 | 7 6 5 | 4 3 2 1 0 |

| | | | | |
|---|---|---|---|---|
| 0 | Command | V | Status | Tree Index |

| | | |
|---|---|---|
| 1 | Node Pointer | Node Type |

| | |
|---|---|
| 2 | Key |
| 5 | |

Application circuits specify the operation to be performed in the Command field, along with the Tree Index, Node Pointer, and Key, as applicable for the specified command. The Node Type field is specified by an application circuit in the request, and is reflected in the Node Type field of the AVL Change Notification response. The Node Type is used by the application circuit to resolve the usage of the TREE_NODE (e.g., for cache look-up, region locks, sorted writes, etc.). The Node Type field may overlay the least significant five bits of the Node Pointer. Because the TREE_NODE structures are 32-byte aligned, these least-significant five bits are masked off and set to zero when using the 32-bit value as a TREE_NODE pointer. A request may be posted either to the synchronous request queue or to the asynchronous request queue. Prior to posting a request, the application circuit sets the Status and V fields to an initialized value (e.g., 0 or −1). Reading a non-initialized value from the V or Status field indicates tree management circuit has completed processing the request. In one exemplary embodiment, only one request may be outstanding on the synchronous request interface at a time. Application circuits should service the response on the synchronous response queue before servicing any replies on the asynchronous response queue and before submitting any new AVL Tree requests.

Application circuits should be adapted to avoid overflowing the asynchronous request queue. The application interface 200 of FIGS. 2 and 4 may include status registers indicating the Max Depth of the FIFOs and indicating the Current Depth of the FIFOs. The application circuits may determine the maximum depth and the current depth of the request FIFO by reading the Max Depth and Current Depth fields of the status registers. If the request FIFO is full, the application circuits must defer issuing a new request. Well-known atomic memory semaphore circuit designs may be implemented to assure there will be no errors or conflicts in this processing for implementations involving more than one I/O processor (e.g., more than one general-purpose processor and/or I/O request processing circuit).

Prior to posting any response (synchronous or asynchronous), the tree management circuit 202 of FIGS. 2 and 4 may set the V bit and store an indication of the result in the Status field, along with the node pointer, if applicable. For replies to asynchronous requests, the tree management circuit should not modify the Node Type field in the request. Application circuits may use this to resolve the context surrounding the returned node. The following pseudo-code example shows typical processing in an application circuit for assuring that the maximum depths of the FIFOs are not exceeded (pseudo-code representing programmed instructions in a general-purpose processor or logic circuits in an I/O processor of the storage controller).

#define CacheHdrNodeType 2
typedef struct _AVL_ReqResp {

unsigned short treeIndex;
signed char status;
unsigned char command;
union {

unsigned long NodePointer;
unsigned char pad[3];
unsigned char NodeType;

}
long long keyLow;
long long keyHigh;

} AVL_ReqResp;
unsigned long r_FIFO_value = *(AVLAsyncResponseFIFO);
AVL_ReqResp *arp = (AVL_ReqResp *)r_FIFO_value;
TREE_NODE *tnp;
Unsigned char nType;
if (arp−>Status == (VALID + AVL_FOUND)) {

tnp = (TREE_NODE *)(arp−>NodePointer & 0xFFFFFF00);
nType = arp−>NodeType;
if (nType == CacheHdrNodeType) {

CacheHeader *chp = (CacheHeader *)((unsigned int)tnp −

offsetof(CacheHeader,TREE_NODE));

unsigned short ld_num = tnp−>treeIndex −
LD0_TREE_INDEX;
ProcessCacheLine(ld_num, chp);

} else if (nType == SOMETHING_ELSE) {

. . .

}

}

The following describes additional exemplary details of the logic in the tree management circuit 202 for processing each of the above exemplary tree management requests in the context of AVL tree management.

### TreeSearch

The requesting application circuit provides the Key and the Tree Index in the AVL Tree request descriptor (i.e., in the async request FIFO or the sync request interface). Starting at the root node of the identified tree, the tree management circuit walks (traverses in key value order) nodes in the AVL tree until it finds a matching key. The traversal is complete if a node is found with a matching key value, if two connecting nodes with keys that fall on either side of the specified key are encountered, or a node with a key that falls on one side of the provided key is encountered with no children in the direction of the specified key relative to the located node key. If a node is found matching the specified key the tree management circuit returns a pointer to the matching node in the Node Pointer of the response descriptor with the Status set to FOUND. If the tree does not contain a node matching the specified key, the tree management circuit sets the Node Pointer of the response descriptor to NULL and the Status to MISSING.

### TreeSearchNearest (a.k.a., TreeFind)

The requesting application circuit provides the Key and the Tree Index in the AVL Tree request descriptor. If the identified tree is not empty (root≠NULL), starting at the root, the tree management circuit walks the AVL tree until it finds the node with a key value closest to, but not less than, the specified key. If a node with a key equal to or greater than the value of the specified key is found, the tree management circuit sets the Node Pointer of the response descriptor to the node with a key that is closest to, but not less than the value of the specified key, and sets the Status field of the response descriptor to FOUND. If the tree contains no nodes with a key that is greater than or equal to the value of the specified key, the Node Pointer is set to NULL, and sets the Status field to MISSING.

### TreeSuccessor

The requesting application circuit provides, in the AVL Tree request descriptor, a pointer to a TREE_NODE that is already in the AVL tree and the Tree Index. The tree management circuit finds the node with the lowest key value that is greater than the key value of the specified node by traversing the left links to the first NULL link, starting with the right child of the specified node. This is used to facilitate identification of rotation nodes for rebalancing the tree.

### TreePredecessor

The requesting application circuit provides, in the AVL Tree request descriptor, a pointer to a TREE_NODE that is already in the AVL tree and the Tree Index. The tree management circuit finds the node with the highest key value that is less than the key value of the specified node by traversing the right links to the first NULL link, starting with the left child of the specified node.

### TreeInsert

The requestor provides, in the AVL Tree request descriptor, a pointer to a TREE_NODE to be placed into the AVL tree identified by the supplied Tree Index. The tree management circuit finds the branch to insert the new node. The tree management circuit navigates left and right to find a leaf node such that the key value of the new node is between the key values of the leaf node and its parent (smaller keys go left, higher keys go right). The leaf becomes the inserted node's parent. The tree management circuit rebalances the tree towards the root (this should require no more than two node rotations).

### TreeDelete

The requestor provides, in the AVL Tree request descriptor, a pointer to a TREE_NODE that is already in the AVL tree identified by the Tree Index. The tree management circuit will delete the specified node from the tree; swapping the “successor” branch into the deleted node's slot in case the deleted node had two children; and then rebalance the tree upwards.

### Tree Management Asynchronous Request/Response Flow Control

Those of ordinary skill in the art will recognize the desirability of arbitration logic and atomicity of operations in interfacing between the application circuits and the tree assist circuit. For example, the tree assist circuit's response FIFO may be a simple hardware FIFO circuit with a limited number of entries. To avoid overflowing the asynchronous response FIFO, application circuits should keep a count of outstanding requests, and suspend issuing new requests when there are as many requests outstanding as there are available entries in the response FIFO. When a queue-full condition occurs, the application circuits should queue asynchronous requests internally or otherwise delay issuing new requests. The request/response descriptor does not contain linking elements, so the linking used to queue the requests within the application circuits should be provided in an application circuit construct that includes or references the request/response descriptor.

If more than one processing core (application circuit) issues requests to the same tree data structure, the application circuit's algorithm is used to access the tree should guarantee atomic access. This includes a requirement to use a memory semaphore to count the number of outstanding requests for detection of the queue-full condition. This should involve acquiring a memory semaphore and/or the use of atomic linked list updates.

Likewise, any processing core (application circuit) may service the asynchronous response queue. However, if a response is retrieved for an asynchronous request issued by a different processor core (indicated in the application specific context fields associated with the tree request), the application may forward the response to the other core via a message (e.g., by placing the context containing the request/response descriptor on a queue serviced by the other core).

When the tree assist circuit has multiple asynchronous replies pending, application circuits should retrieve all outstanding replies before issuing new tree management requests. After retrieving all outstanding replies, the application circuits should check any application circuit pending request queue (within the application circuits) and issue as many requests to the tree assist circuit as possible before encountering a queue-full condition.

If the tree assist circuit has more than one pending response available after the application circuits read the first response from the response FIFO register, the tree assist circuit will have the second response available in the register before the application circuit reads the response FIFO register again. A value of 0xFFFFFFFF read from the response FIFO indicates no more responses are available.

### Tree Management Synchronous Request/Response Flow Control

An application circuit may issue a synchronous tree management request in circumstances that require a response before processing can continue. There may be only one synchronous request pending at any point in time. After issuing a synchronous request, the application circuit should poll the synchronous response register before issuing any new tree management requests, and continue polling the synchronous response register until the response is available.

All processing cores (application circuits) may have access to the synchronous request register. To prevent multiple concurrent synchronous requests, access to the synchronous request and response registers should be protected using a memory semaphore to provide atomic access spanning both issuance of the request and fetching of the response.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. Apparatus in a storage controller of a storage system for managing tree data structures, the apparatus comprising:
a memory adapted to store a plurality of tree node data structures, the memory further adapted to store a plurality of tree information data structures, each tree information data structure adapted to identify a root tree node data structure;
an application interface circuit adapted to couple with an application circuit in the storage system and adapted to receive a request from the application circuit to access an identified tree data structure and adapted to return information to the application circuit based on access to the identified tree data structure, the application interface circuit comprising a tree information configuration register adapted to store a starting address in the memory for the plurality of tree information data structures; and
a tree management circuit coupled with the application interface circuit and coupled with the memory, the tree management circuit adapted to access an identified tree data structure in the memory in response to a request received from an application circuit through the application interface circuit.

2. The apparatus of claim 1
wherein the tree management circuit further comprises:
a tree search circuit adapted to locate identified information in the identified tree data structure and adapted to return the located information regarding the identified tree data structure.

3. The apparatus of claim 1
wherein the tree management circuit further comprises:
a tree modification circuit adapted to modify an identified tree data structure.

4. The apparatus of claim 3
wherein the tree modification circuit further comprises:
a tree node insertion circuit adapted for inserting an identified node in the identified tree data structure; and
a tree node deletion circuit adapted for deleting an identified node in the identified tree data structure.

5. The apparatus of claim 3
wherein the tree modification circuit further comprises:
a tree rotation circuit adapted for rotating the identified tree data structure to re-balance the identified tree data structure.

6. The apparatus of claim 1
wherein the root tree node is the root of an AVL tree data structure.

7. The apparatus of claim 1
wherein the application interface circuit further comprises:
a request FIFO memory adapted to receive and store requests from one or more application circuits; and
a response FIFO memory adapted to receive and store responses from the tree management circuit in response to processing one or more requests.

8. The apparatus of claim 7
wherein the application interface circuit further comprises:
a synchronous request interface adapted to receive and store a single request from an application circuit; and
a synchronous response interface adapted to receive and store a single response from the tree management circuit in response to processing the single request.

9. A storage controller comprising:
a front-end interface adapted for coupling the storage controller to a host system;
a back-end interface adapted to couple the storage controller to a plurality of storage devices;
a general-purpose processor coupled with the back-end interface and coupled with the front-end interface, the general-purpose processor adapted to receive a host system I/O request through the front-end interface and adapted to process a received I/O request by accessing storage devices through the back-end interface;
an I/O request processor coupled with the back-end interface and coupled with the front-end interface and coupled with the general-purpose processor, the I/O request processor adapted to receive a host system I/O request through the front-end interface and adapted to process a received I/O request by accessing storage devices through the back-end interface;
a memory adapted to store a plurality of tree node data structures, the memory further adapted to store a plurality of tree information data structures, each tree information data structure adapted to identify a root tree node data structure; and
a tree assist circuit coupled with the general-purpose processor and coupled with the I/O request processor and coupled with the memory, the tree assist circuit comprising:
a tree information configuration register adapted to store a starting address in the memory for the plurality of tree information data structures; and
a tree management circuit coupled with the tree information configuration register and coupled with the memory, the tree management circuit adapted to access an identified tree data structure in the memory,
the tree assist circuit adapted to receive a request from the general-purpose processor and/or from the I/O request processor to access an identified tree data structure and adapted to return information to the requesting processor based on access to the identified tree data structure.

10. The storage controller of claim 9
wherein the tree management circuit further comprises:
a tree search circuit adapted to locate identified information in the identified tree data structure and adapted to return to the requesting processor the located information regarding the identified tree data structure.

11. The storage controller of claim 9
wherein the tree management circuit further comprises:
a tree modification circuit adapted to modify an identified tree data structure in accordance with the request from the requesting processor.

12. The storage controller of claim 11
wherein the tree modification circuit further comprises:
a tree node insertion circuit adapted for inserting an identified node in the identified tree data structure; and
a tree node deletion circuit adapted for deleting an identified node in the identified tree data structure.

13. The storage controller of claim 11
wherein the tree modification circuit further comprises:
a tree rotation circuit adapted for rotating the identified tree data structure to re-balance the identified tree data structure.

14. The storage controller of claim 9
wherein the root tree node is the root of an AVL tree data structure.

15. A method operable in a storage controller, the storage controller comprising an I/O request processor and a tree assist circuit and a memory, the method comprising:
receiving an I/O request from an attached host system;
transmitting a tree management request from the I/O request processor to the tree assist circuit;
receiving in the tree assist circuit a request from the I/O request processor, the request for access to an identified tree data structure stored in the memory; and
accessing, by operation of the tree assist circuit, the identified tree data structure wherein the step of accessing further comprises one or more of the steps of:
modifying the identified tree data structure; and
returning information from the identified tree data structure.

16. The method of claim 15
wherein the step of modifying further comprises one or more of the steps of:
modifying information stored in a node of the identified tree data structure;
inserting a new node in the identified tree data structure;
deleting a node in the identified tree data structure; and
re-balancing the identified tree data structure.
